(19) United States
(12) Patent Application Publication
(10) Pub. No.: US 2021/0393463 A1
(43) Pub. Date: Dec. 23, 2021

(54) SCREW-TYPE LIFTING AND TURNING MACHINE

(71) Applicant: FAR EAST UNIVERSITY, Tainan City (TW)

(72) Inventor: YU-GANG CHEN, TAINAN CITY (TW)

(21) Appl. No.: 17/134,700

(22) Filed: Dec. 28, 2020

(30) Foreign Application Priority Data
Jun. 17, 2020 (TW) 109120474

(51) Int. Cl. A61G 7/10; F16H 37/12

(52) U.S. Cl. CPC A61G 7/1015; F16H 37/122; A61G 7/1055

(57) ABSTRACT

A screw-type lifting and turning machine includes a base, a bracket, and a lifting device. The lifting device has one or two sets of screw rods and nuts. By rotating the screw rods to raise and descend the nut, the patient on the bed can be changed from lying to side-lying, and the direction of the side-lying can be changed periodically.

### FIELD OF THE INVENTION

The present invention relates to an auxiliary device, and more particularly to a screw-type lifting and turning machine.

### BACKGROUND OF THE INVENTION

Many patients who have been bedridden for a long time cannot turn themselves sideways because they have difficulty in moving, resulting in long-term pressure on the body, poor blood circulation, muscle necrosis and other commonly known conditions as bedsores. Bedsore caused by the reproduction of pyogenic bacteria may endanger the lives of patients if they delay in seeking medical attention. In order to prevent the patient from bedsores, nursing staff or family members need to turn the patient sideways every two hours to change the body posture. It is necessary to turn the patient sideways several times a day, and some critically ill patients require two or three nurses to work together to complete the turn.

### SUMMARY OF THE INVENTION

In view of the shortcomings of the prior art, the primary object of the present invention is to provide a screw-type lifting and turning machine for lifting a mat body. The screw-type lifting and turning machine comprises a base, a bracket disposed on the base, and a lifting device. The lifting device is disposed on the bracket and/or the base. The lifting device includes a first sling, a first pulley set, a first screw rod, a first nut, and a first driving member. The first pulley set is disposed on the bracket. The first driving member is configured to drive the first screw rod for screwing up or screwing down the first nut. The first sling is arranged on the first pulley set. One side of the first sling is used for hanging a first side of the mat body. Another side of the first sling is connected to the first nut so that the first sling can lower or pull up the first side of the mat body by rising or descending the first nut.

Preferably, the lifting device further includes a second sling, a second pulley set, a second screw rod, a second nut, and a second driving member. The second pulley set is disposed on the bracket. The second driving member is configured to drive the second screw rod for screwing up or screwing down the second nut.

Preferably, the second sling is arranged on the second pulley set. One side of the first sling is used for hanging a second side of the mat body. Another side of the second sling is connected to the second nut so that the second sling can lower or pull up the second side of the mat body by rising or descending the second nut.

Preferably, the screw-type lifting and turning machine further comprises a limiting rod. The first nut has a first limiting groove abutting on one side of the limiting rod so as to rise and descend along with rotation of the first screw rod. The second nut has a second limiting groove abutting on another side of the limiting rod so as to rise and descend along with rotation of the second screw rod.

Preferably, the first screw rod, the first nut, the second screw rod and the second nut of the lifting device are arranged inside the bracket.

Alternatively, the first screw rod, the first nut, the second screw rod and the second nut of the lifting device are arranged outside the bracket.

Preferably, the screw-type lifting and turning machine further comprises a first hollow cable sleeve and a second hollow cable sleeve respectively fixed to two ends of the bracket. The first hollow cable sleeve and the second hollow cable sleeve are movably sleeved on outer sides of the first sling and the second sling, respectively.

Preferably, the first sling and the second sling are steel cables each covered with a protective layer.

Preferably, the first driving member and the second driving member intermittently, alternately rise and descend the first nut and the second nut, so that the first side and the second side of the mat body are intermittently, alternately raised and lowered.

Preferably, the base has at least two pivotal support legs.

The screw-type lifting and turning machine of the present invention can be pushed to move its position, and has one or two sets of screw rods and nuts to rise and descend one or two slings. In addition, the two sides of the mat body can be raised and lowered periodically, so that the patient can change from lying to side-lying intermittently or periodically, and the direction of side-lying can be alternately changed.

Embodiments of the present invention will now be described, by way of example only, with reference to the accompanying drawings.

### BRIEF DESCRIPTION OF THE DRAWINGS

FIG. 1 is a perspective view of the screw-type lifting and turning machine of a first embodiment of the present invention;

FIG. 2 is a schematic view of the first embodiment of the present invention, showing the first sling connected to the first pulley and the second sling connected to the second pulley;

FIG. 3 is a rear view of the screw-type lifting and turning machine of the first embodiment of the present invention;

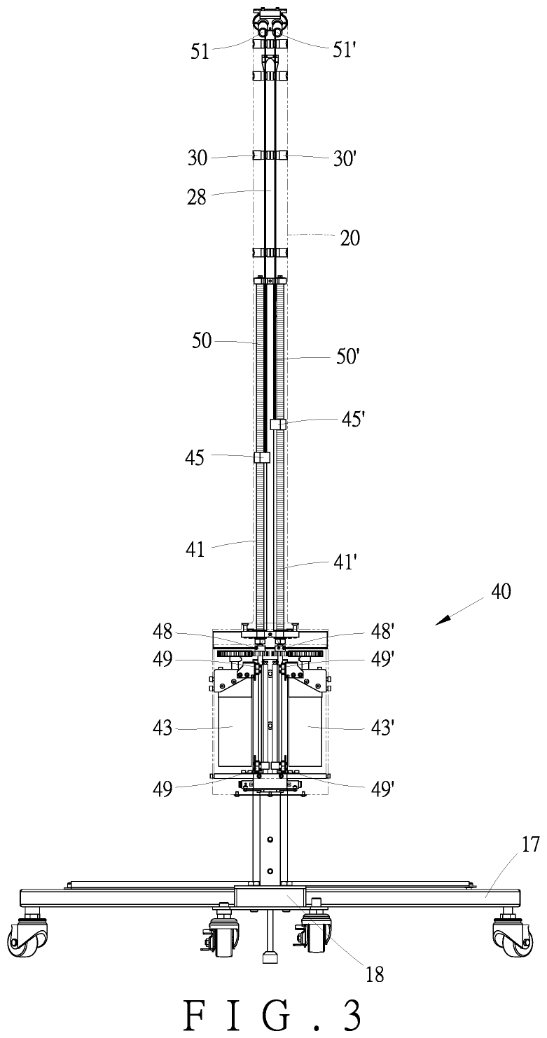

FIG. 4 is a schematic view of the first embodiment of the present invention, showing the driving member of the lifting device of the screw-type lifting and turning machine;

FIG. 5 is a schematic view of the first embodiment of the present invention, showing the screw rod and the nut of the lifting device of the screw-type lifting and turning machine;

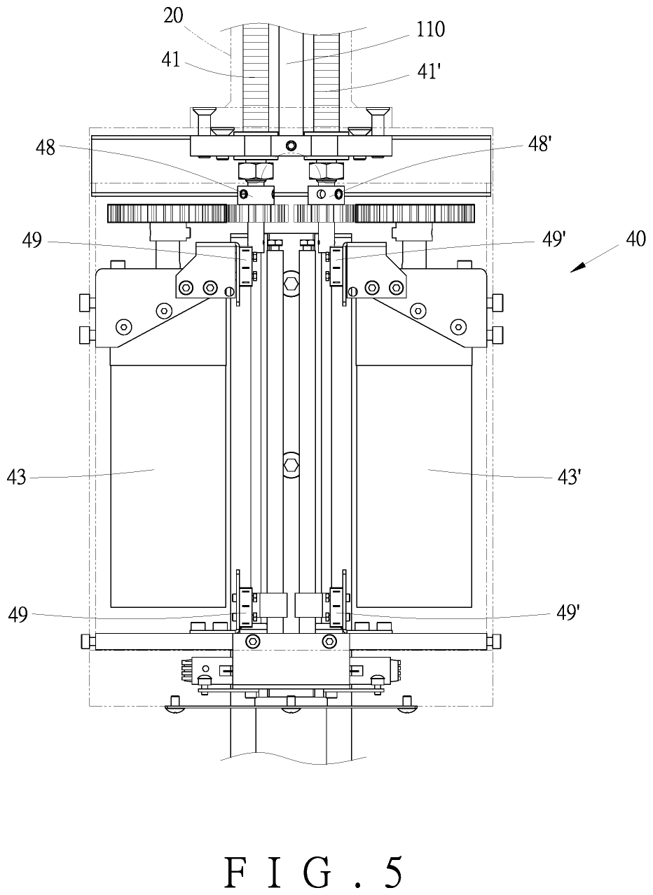

FIG. 6 is a side schematic view of the screw-type lifting and turning machine of the first embodiment of the present invention; and

FIG. 7 is a side schematic view of the screw-type lifting and turning machine of a second embodiment of the present invention.

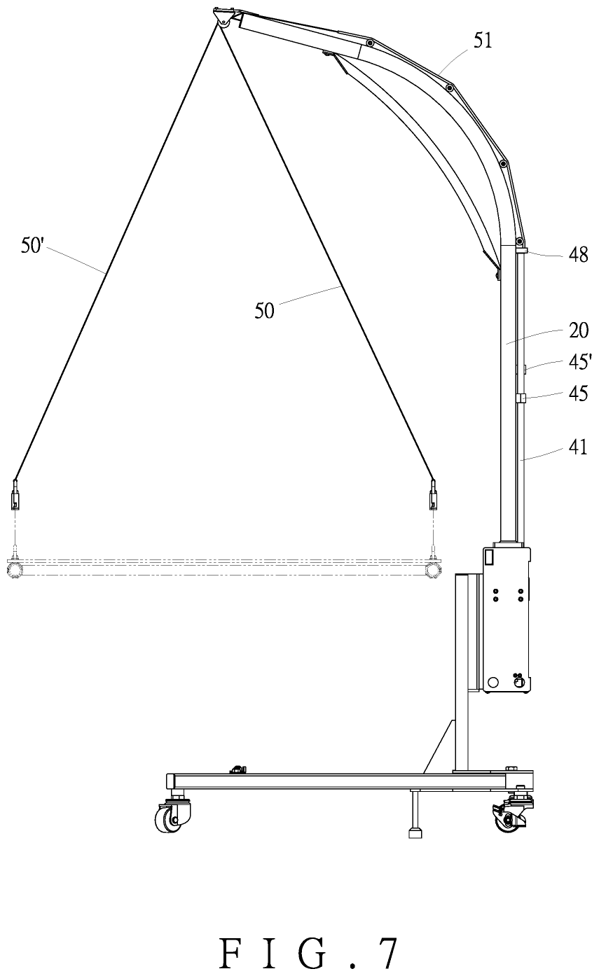

### DESCRIPTION OF THE PREFERRED EMBODIMENTS

In order to understand the technical features, content and advantages of the present invention and the effects that can be achieved, example embodiments will be described in more detail with reference to the accompanying drawings, in which like reference numbers refer to like elements throughout. The present invention, however, may be embodied in various different forms, and should not be construed as being limited to only the illustrated embodiments herein. In the drawings, the relative sizes of elements, layers, and regions may be exaggerated for clarity.

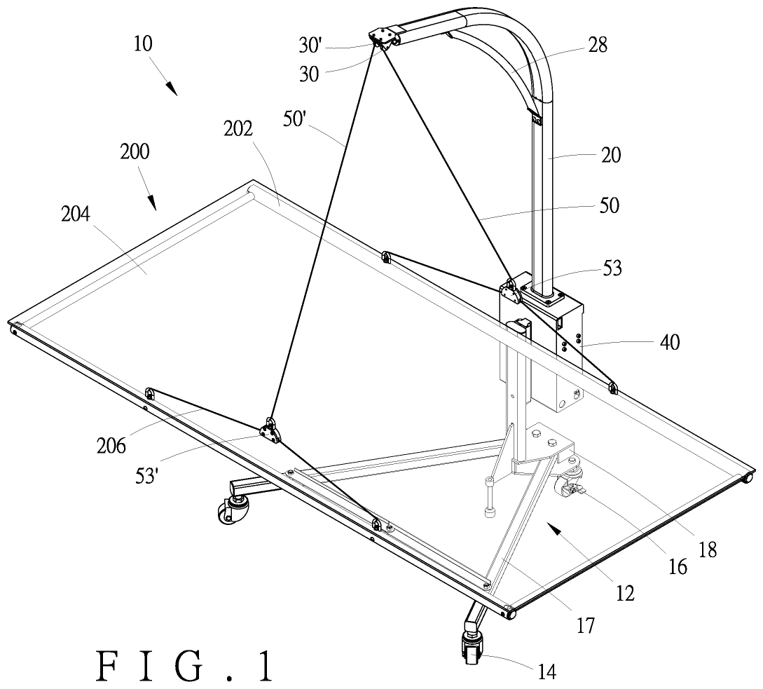

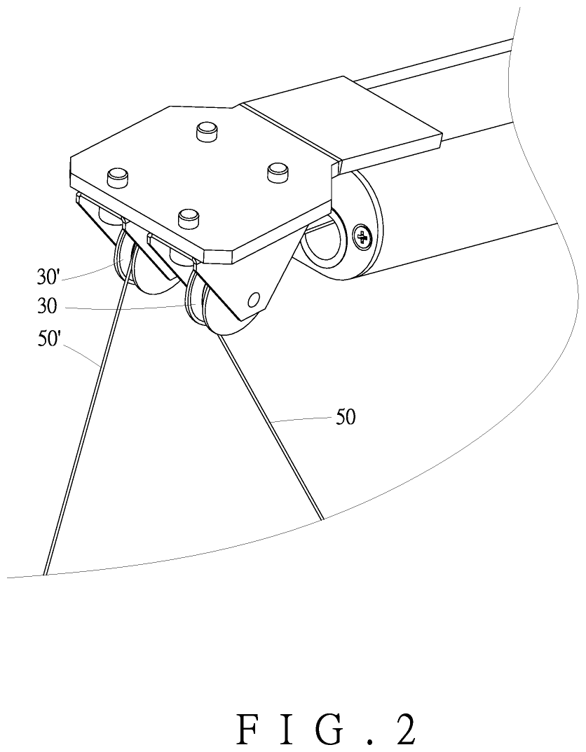

As shown in FIG. 1 through FIG. 2, a screw-type lifting and turning machine 10 of the present invention is used for lifting the first side and the second side of a mat body 200 intermittently and alternately. The screw-type lifting and turning machine 10 comprises a base 12, a bracket 20 and a lifting device 40. The base 12 has at least two support legs 17 pivotally connected to a seat 18, and can be stored or unfolded for use by changing the angle between the two support legs 17. Preferably, the base 12 has casters 14 for moving the screw-type lifting and turning machine 10 to a desired position. At least one of the casters is a brake caster 16 for preventing the screw-type lifting and turning machine 10 from moving when in use. The bracket 20 is disposed on the base 12. The bracket 20 is, for example, an inverted L-shaped structure, including an arc-shaped rod and a straight rod. The bottom end of the bracket 20 is connected to the base 12. When the mat body 200 is raised and lowered, the top end of the bracket 20 is suspended above the mat body 200. In addition, the bracket 20 further selectively includes a reinforcing arm 28. Two sides of the reinforcing arm 28 are respectively connected to two sides of the bracket 20 for increasing the structural strength.

The technical feature of the present invention is that the lifting device 40 is disposed on the bracket 20 and/or the base 12. The lifting device 40 includes a first sling 50, a first pulley set 30, a first screw rod 41, a first nut 45, and a first driving member 43. The first pulley set 30 is disposed on the bracket 20. The number of the first pulley set 30 may be one or more. The first pulley set 30 may be, for example, only disposed on the top end of the bracket 20 and/or other positions of the bracket 20, such as on the inner surface or the outer surface. The first nut 45 is screwedly connected to the first screw rod 41. The first driving member 43 is, for example, a motor or a motor with a reduction mechanism, and drives the first screw rod 41 to rotate, for example, via a gear set. The first nut 45 has a first limiting groove 47 abutting on one side of a limiting rod 110 to provide a self-locking effect. For example, a controller (not shown in the figure) is used to control the rotation direction of the first screw rod 41 to screw up or screw down the first nut 45. Two ends of the first screw rod 41 are respectively connected to a first bearing 48. The first bearing 48 is fixed to the bracket 20, so the gear on the first screw rod 41 can be driven by the gear on the shaft of the first driving member 43 to rotate, so that the first screw rod 41 rotates at a fixed point. As shown in FIG. 2, the first sling 50 is arranged on the first pulley set 30. One side of the first sling 50 has, for example, a first hook 53 for hanging a first side of the mat body 200. The other side of the first sling 50 is connected to the first nut 45, so that the first sling 50 can lower or pull up the first side of the mat body 200 by rising or descending the first nut 45. In the present invention, for example, the rotation direction of the first screw rod 41 is controlled by a controller so that the first nut 45 rises or descends. When the first nut 45 of the present invention rises, the first sling 50 lowers the first side of the mat body 200, on the contrary, when the first nut 45 of the present invention descends, the first sling 50 raises the first side of the mat body 200. In addition, the lifting device 40 of the present invention further has, for example, two first limit switches 49 for transmitting a stop signal to the controller when the first side of the mat body 200 reaches the highest point and the lowest point, respectively. The material and form of the mat body 200 are not particularly limited. It may be, for example, textiles such as fabrics, fitted sheets, sleeping mats or other structures, as long as the patient in the bed can lie on the mat body 200, it can be applied to the present invention. As shown in the figure, the mat body 200 of the present invention is composed of rods 202, supports 204 and steel cables 206, taken as an example. The rods 202 are connected to the two sides or the periphery of the supports 204. The two opposite sides of the rods 202 are connected with the steel cables 206. The first hook 53 of the first sling 50 hoists the mat body 200 through the steel cable on the first side of the mat body 200, for example. Therefore, the first sling 50 can lift the mat body 200 on the first side, so that the patient can turn sideways from head to toe, instead of pulling only a partial area. In order to avoid blocking other components, the mat body 200 is a transparent structure taken as an example, but it is not intended to limit the present invention.

The lifting device 40 of the present invention further includes a second sling 50′, a second pulley set 30′, a second screw rod 41′, a second nut 45′, and a second driving member 43′. The number of the second pulley set 30′ may be one or more. The second pulley set 30′ may be, for example, only disposed on the top end of the bracket 20 and/or other positions of the bracket 20, such as on the inner surface or the outer surface. The second nut 45′ is screwedly connected to the second screw rod 41′. The second driving member 43′ is, for example, a motor or a motor with a reduction mechanism, and drives the second screw rod 41′ to rotate, for example, via a gear set. The second nut 45′ has a second limiting groove 47′ abutting on the other side of the limiting rod 110 to provide a self-locking effect. For example, the controller is used to control the rotation direction of the second screw rod 41′ to screw up or screw down the second nut 45′. Two ends of the second screw rod 41′ are respectively connected to a second bearing 48′. The second bearing 48′ is fixed to the bracket 20, so the gear on the second screw rod 41′ can be driven by the gear on the shaft of the second driving member 43′ to rotate, so that the second screw rod 41′ rotates at a fixed point. The second sling 50′ is arranged on the second pulley set 30′. One side of the second sling 50′ has, for example, a second hook 53′ for hanging a second side of the mat body 200. The other side of the second sling 50′ is connected to the second nut 45′, so that the second sling 50′ can lower or pull up the second side of the mat body 200 by rising or descending the second nut 45′. In the present invention, for example, the rotation direction of the second screw rod 41′ is controlled by a controller so that the second nut 45′ rises or descends. When the second nut 45′ of the present invention rises, the second sling 50′ lowers the second side of the mat body 200, on the contrary, when the second nut 45′ of the present invention descends, the second sling 50′ raises the second side of the mat body 200. In addition, the lifting device 40 of the present invention further has, for example, two second limit switches 49′ for transmitting a stop signal to the controller when the second side of the mat body 200 reaches the highest point and the lowest point, respectively. The first driving member 43 and the second driving member 43′ of the present invention alternately rises and descends the first nut 45 and the second nut 45′ intermittently, so that the first side and the second side of the mat body 200 are intermittently, alternately raised and lowered.

The present invention can alternately raise and lower the first side and the second side of the mat body 200 intermittently. For example, in the present invention, the first side of the mat body 200 disposed on a bed body is raised and stayed for about 30 minutes, and then it is lowered to be in contact with the bed body. After that, the second side of the mat body 200 is raised and stayed for about 30 minutes, and then it is lowered to be in contact with the bed body. In addition, the present invention can perform the above-mentioned intermittent alternate lifting and lowering every two hours, so that the patient on the mat body 200 can turn right and left regularly. Thereby, the present invention can automatically, intermittently, alternately turn a patient sideways, so as to effectively save nursing manpower.

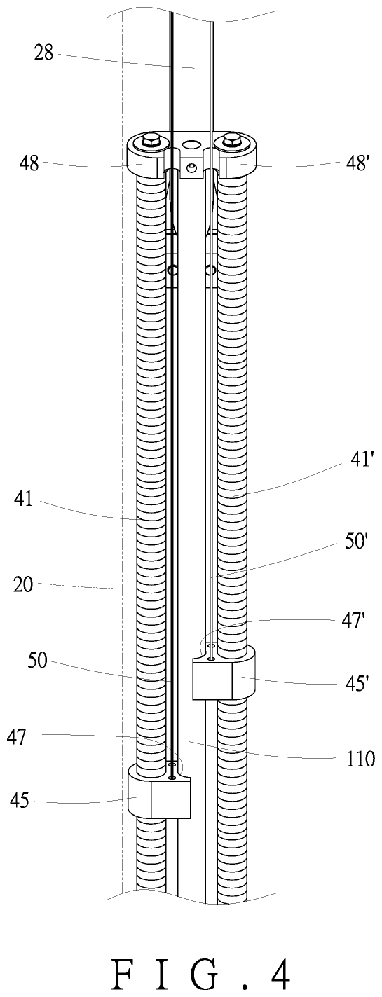

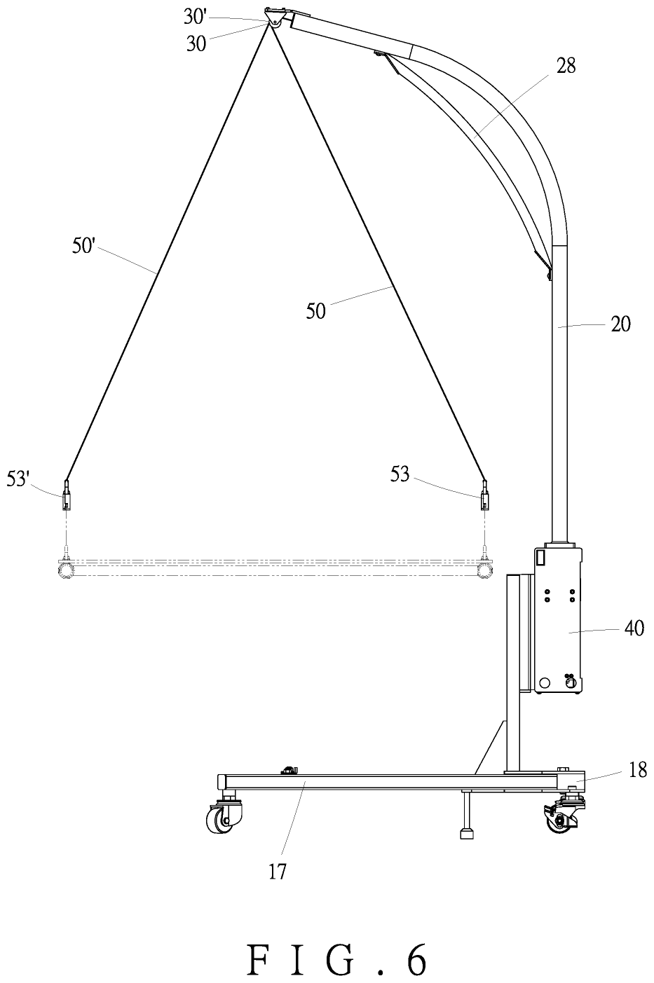

In the first embodiment of the present invention, as shown in FIG. 4, the bracket 20 is hollow. The first screw rod 41, the first nut 45, the second screw rod 41′ and the second nut 45′ of the lifting device 40 are arranged inside the bracket 20, and part of the first sling 50 and the second sling 50′ are located inside the bracket 20. In the second embodiment of the present invention, the bracket 20 is hollow or solid. The first screw rod 41, the first nut 45, the second screw rod 41′ and the second nut 45′ of the lifting device 40 are arranged outside the bracket 20, and all or part of the first sling 50 and the second sling 50′ are located outside the bracket 20. In addition, in the second embodiment, as shown in FIG. 6, the present invention can selectively have a protective cover to cover the first screw rod 41, the first nut 45, the second screw rod 41′ and the second nut 45′ located outside the bracket 20. The protective cover may be a cloth cover, a leather cover, a plastic tubular cover or a metal tubular cover. In addition, in the first and second embodiments, the first sling 50 and the second sling 50′ can be provided on the inner surface and the outer surface of the bracket 20 through, for example, the first pulley set 30 and second pulley set 30′ or positioning members having positioning grooves respectively, so as to prevent the first sling 50 and the second sling 50′ from moving left and right during the lifting process.

In addition, in the first and second embodiments, the screw-type lifting and turning machine of the present invention selectively further includes a first hollow cable sleeve 51 and a second hollow cable sleeve 51′ respectively fixed to the two ends of the bracket 20. The first hollow cable sleeve 51 and the second hollow cable sleeve 51′ are movably sleeved on the outer sides of the first sling 50 and the second sling 50′, respectively. The first hollow cable sleeve 51 and the second hollow cable sleeve 51′ are made of, for example, rubber, plastic or metal, and can selectively have lubricating materials inside, such as dry self-lubricating materials such as Teflon or, for example, wet self-lubricating materials with a lubricating fluid. The first sling 50 and the second sling 50′ are preferably steel cables each covered with a protective layer. The protective layer is made of, for example, a rubber material to prevent the steel cable from being damaged by friction. The friction force between the first sling 50 and the second sling 50′ and the first hollow sling 51 and the second hollow sling 51′ of the present invention is less than that between the first sling 50 and the second sling 50′ and the bracket 20. Therefore, by reducing the friction force, the force required for lifting the mat body 200 can be saved, and the wear and tear of the first sling 50 and the second sling 50′ during the lifting process can be reduced. Furthermore, in the first and second embodiments, the first sling 50 and the second sling 50′ can be provided on the inner surface and the outer surface of the bracket 20 through, for example, the first pulley set 30 and second pulley set 30′ or positioning members having positioning grooves respectively, so as to prevent the first sling 50 and the second sling 50′ from moving left and right during the lifting process.

The screw-type lifting and turning machine of the present invention can be pushed to move its position, and has one or two sets of screw rods and nuts to lift one or two slings. In addition, the two sides of the mat body can be raised and lowered periodically, so that the patient can change from lying to side-lying intermittently or periodically, and the direction of side-lying can be alternately changed.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A screw-type lifting and turning machine for lifting a mat body, comprising:
a base;
a bracket disposed on the base; and
a lifting device, disposed on the bracket and/or the base, the lifting device including a first sling, a first pulley set, a first screw rod, a first nut and a first driving member, the first pulley set being disposed on the bracket, the first driving member being configured to drive the first screw rod for screwing up or screwing down the first nut, the first sling being arranged on the first pulley set, one side of the first sling being used for hanging a first side of the mat body, another side of the first sling being connected to the first nut so that the first sling can lower or pull up the first side of the mat body by rising or descending the first nut.

2. The screw-type lifting and turning machine as claimed in claim 1, wherein the lifting device further includes a second sling, a second pulley set, a second screw rod, a second nut and a second driving member, the second pulley set is disposed on the bracket, and the second driving member is configured to drive the second screw rod for screwing up or screwing down the second nut.

3. The screw-type lifting and turning machine as claimed in claim 2, wherein the second sling is arranged on the second pulley set, one side of the first sling is used for hanging a second side of the mat body, and another side of the second sling is connected to the second nut so that the second sling can lower or pull up the second side of the mat body by rising or descending the second nut.

4. The screw-type lifting and turning machine as claimed in claim 3, further comprising a limiting rod, the first nut having a first limiting groove abutting on one side of the limiting rod so as to rise and descend along with rotation of the first screw rod, the second nut having a second limiting groove abutting on another side of the limiting rod so as to rise and descend along with rotation of the second screw rod.

5. The screw-type lifting and turning machine as claimed in claim 2, wherein the first screw rod, the first nut, the second screw rod and the second nut of the lifting device are arranged inside the bracket.

6. The screw-type lifting and turning machine as claimed in claim 2, wherein the first screw rod, the first nut, the second screw rod and the second nut of the lifting device are arranged outside the bracket.

7. The screw-type lifting and turning machine as claimed in claim 3, further comprising a first hollow cable sleeve and a second hollow cable sleeve respectively fixed to two ends of the bracket, the first hollow cable sleeve and the second hollow cable sleeve being movably sleeved on outer sides of the first sling and the second sling, respectively.

8. The screw-type lifting and turning machine as claimed in claim 7, wherein the first sling and the second sling are steel cables each covered with a protective layer.

9. The screw-type lifting and turning machine as claimed in claim 3, wherein the first driving member and the second driving member intermittently, alternately rise and descend the first nut and the second nut, so that the first side and the second side of the mat body are intermittently, alternately raised and lowered.

10. The screw-type lifting and turning machine as claimed in claim 1, wherein the base has at least two pivotal support legs.
